(19) United States
(12) Patent Application Publication
(10) Pub. No.: US 2008/0208830 A1
(43) Pub. Date: Aug. 28, 2008

(54) AUTOMATED TRANSFORMATION OF STRUCTURED AND UNSTRUCTURED CONTENT

(75) Inventors: Greg Lauckhart, Seattle, WA (US); Nicholas Kushmerick, Seattle, WA (US)

Correspondence Address: DARBY & DARBY P.C., P.O. BOX 770, Church Street Station, New York, NY, 10008-0770, US

(73) Assignee: QL2 Software, Inc., Seattle, WA (US)

(21) Appl. No.: 12/036,141

(22) Filed: Feb. 22, 2008

Related U.S. Application Data
(60) Provisional application No. 60/891,935, filed on Feb. 27, 2007.

(51) Int. Cl. G06F 7/06

(52) U.S. Cl. 707/4; 707/E17.136

(57) ABSTRACT

A device, system, and method are directed towards enabling a user to employ a set of database-like structured query expressions to manage data retrieval over a network, and the transformation and/or normalization of the data. In one embodiment, the retrieval expressions are configured as database-like structured query commands that may be performed upon at least a non-database arrangement of content over the network. In one embodiment, retrieved data is converted to at least one format intermediate to a first and second format in a sequence of transformations.

### RELATED APPLICATION

This application claims the benefit of U.S. Provisional Application Ser. No. 60/891,935 filed Feb. 27, 2007 the benefit of the earlier filing date is hereby claimed under 35 U.S.C. § 119 (e) and which is further incorporated herein by reference.

### FIELD OF THE INVENTION

The present invention relates generally to network data management tools and, more particularly, but not exclusively to enabling the automated retrieval, transformation, and/or normalization of arbitrary content over a network.

### BACKGROUND OF THE INVENTION

As is generally known in the art, the volume of digital data over the Internet is expected to continue to increase over the coming years. This may not be so surprising considering that more businesses, educational institutions, and the like, are using the Internet. Thus, there are literally terabytes of data potentially accessible over the Internet.

Such a vast resource of data could provide businesses, researchers, consumers, or the like, with information never available to them in the past. However, despite all of this available data, collecting this data into a format that is easy to analyze, can be a time-intensive and expensive endeavor.

For example, while search engines may assist a user in finding some information over a network, today's search engines may be unable to access data that is accessible through steps other than those pertaining to a query. Examples of such data include that which may be provided through execution of an application, requires the user to submit additional information to access the data, or even where the data is in a more unconventional data formats. Moreover, many of today's search engines may return data in a format that is inconsistent with the user's needs. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a network device that may be included in a system implementing the invention;

FIG. 3 illustrates a logical flow diagram generally showing one embodiment of an overview process for managing digital data over a network;

FIG. 4 illustrates a logical flow diagram generally showing the details of one embodiment of a conversion process illustrated in FIG. 3;

FIG. 5 illustrates a data flow diagram showing one embodiment of details of the process illustrated in FIG. 3; and

FIG. 6 illustrates one embodiment of a transition graph for converting between data types.

### DETAILED DESCRIPTION OF THE INVENTION

The present invention now will be described more fully hereinafter with reference to the accompanying drawings, which form a part hereof, and which show, by way of illustrations, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated the present invention is directed towards employing a set of expressions in a database-like structured language syntax to manage data retrieval, often but not necessarily over a network, and the transformation, and/or normalization of the arbitrary content. Arbitrary content includes virtually any digital data, whether it is structured, or un-structured. In one embodiment, the retrieval expressions are configured as database-like structured query clauses that may be performed upon at least a non-database arrangement of content over the network, an application, a form, or even a database. As used herein, the term “database-structured query,” refers to a form of a query that is configured to interrogate related files, documents, applications, or the like, for data.

In one embodiment, the tools are configured to retrieve content from a wide variety of sources. Such sources include but are not limited to those accessible using various standard protocols over a computer network, files in local storage, or those accessible through execution of an arbitrary application, script, applet, or the like. Processes for transforming data may be composed in a reactive and variable manner based on a physical layout of the data, the presence, or absence of a particular user input or preference, the intended use of the data, and/or a logical structure. After the data is transformed, various tools may be applied to arbitrarily normalize the data. In one embodiment, at least some of the normalization tools may be used to ensure that the data conforms to an application-specific requirement.

A programmer may write scripts, or the like, using a database-like structured programming language, which may then be interpreted by a Runtime System. These scripts may include instructions for various components within the Runtime System on how to retrieve, transform, and/or normalize the desired content.

In particular, a programmer, or other user of the Runtime System, may retrieve data sources as specified by a URI, URL, or the like, using a variety of schemes, including, but not limited to HTTP, FTP, ODBC, TCP, UDP, or the like, as well as several propriety schemes, such as “exec” to retrieve data from the output of executing an arbitrary external program; “invoke” to retrieve data from the output of executing code in an arbitrary external component; or even retrieving data recursively invoking the Runtime System on an arbitrary script. For example, in one embodiment, a user may cause an arbitrary external program to execute, and while it is executing, provide automatically through a script, or the like, various inputs, responses to questions, or the like, from the program, and retrieve output data from the program, without having the user to continually interact with the executing program.

The user, or programmer, may further, through query clauses in the script, perform conversions and/or transformations on the content by exporting the data for subsequent processing in either a record-based, a byte-based, or in a file-based format. In one embodiment, the data may be automatically converted from physical to a logical format using a lazy execution of a conditionally and variably composed sequence of operations. In one embodiment, at least some of the procedures may perform one or more of the following:
decode the data (for example, uncompress it, transcode it from one character encoding to another, or the like),
map from one Internet Media Type (IMT) to another IMT,
compose record-based data into a byte-based format,
decompose byte-based data into records according to a “natural” interpretation of the data (for example, such as decomposing a spreadsheet format into its rows and columns of data, or the like), and/or
decompose byte-based data into records according to a user-specified interpretation of the data (for example, such as decomposing a document into a table of images in the document, decomposing a document into hyperlinks in the document, or the like)

Moreover, a mechanism for automatically generating and performing the procedures may, in one embodiment, be based on a shortest sequence of operations to transform the data from the available physical to a logical format used by the script being executed. However, the invention is not so constrained, and other transformation paths may be selected, for example, but not limited to being based on a cost factor indicative of the computational cost of a transform path and/or a computational speed of the transform path. The sequence of transformation may be determined using a logical translation graph or mapping of conversions.

Normalization of retrieved data may be performed using an arbitrary application-specific logic, in one embodiment. For example, in one embodiment, validation rules may be employed that may be indicated with a URL that resolves to an Extensible Markup Language (XML) specification of the validation procedure. Several validation rules are further provided for such as regular expression matching, table lookups based on regular expressions and/or approximate string matching, or the like. In one embodiment, a facility also may be provided for calling out to arbitrary external code.

The retrieval and integration of digital content as described herein may provide several benefits over more traditional approaches. For example, because the approach automatically carries out many routine data retrievals, transformation, and/or normalization processes, a user or programmer, may instead devote more of their effort towards other activities, for example, such as the data management requirements of the application being developed. Processes that might take hundreds or even thousands of lines of code to implement using traditional techniques can be accomplished as described herein with, perhaps, just dozens of lines of script code.

### Illustrative Operating Environment

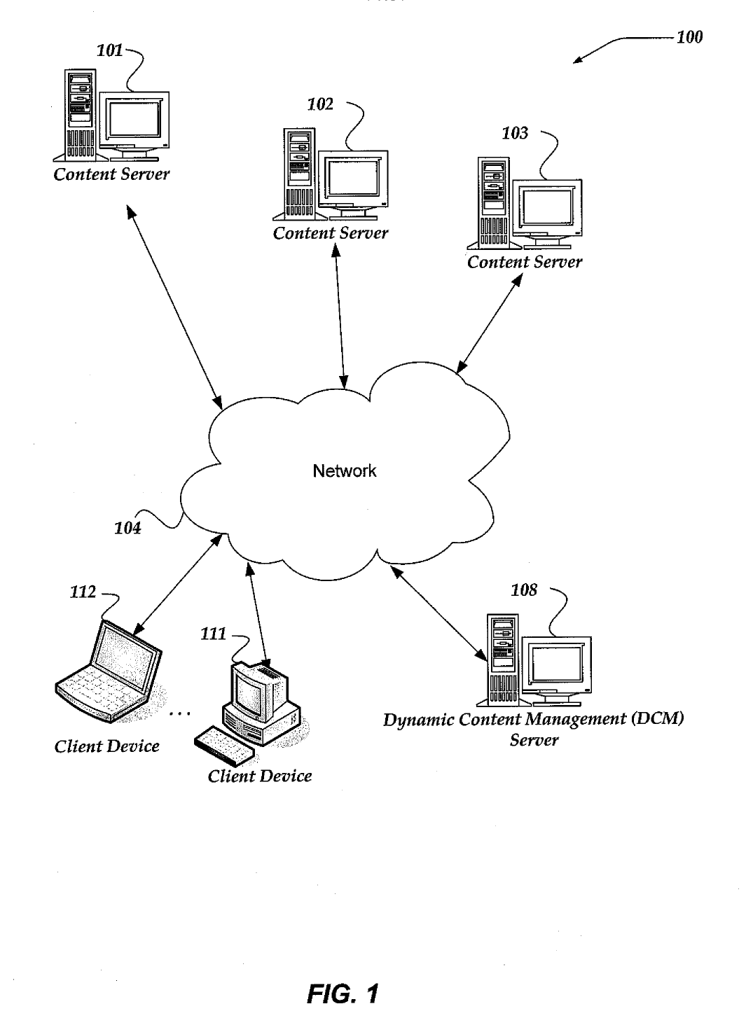

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area network 104, content servers 101-103, client devices 111-112, and Dynamic Content Management (DCM) server 108.

Client devices 111-112 may include virtually any computing device capable of receiving and sending a message over a network, such as network 104, to and from another computing device, such as content servers 101-103, each other, or the like. The set of such devices generally includes mobile devices that are usually considered more specialized devices with limited capabilities and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. However, the set of such devices may also include devices that are usually considered more general purpose devices and typically connect using a wired communications medium at one or more fixed location such as laptop computers, desktops, and the like. Similarly, client devices 111-112 may be any device that is capable of connecting using a wired or wireless communication medium such as a personal digital assistant (PDA), POCKET PC, wearable computer, and any other device that is equipped to communicate over a wired and/or wireless communication medium.

Client devices 111-112 may be configured with a browser application that is configured to receive and to send content in a variety of forms, including, but not limited to markup pages, web-based messages, audio files, graphical files, file downloads, applets, scripts, cookies, and the like. The browser application may be configured to receive and display graphics, text, multimedia, and the like, employing virtually any mobile markup based language or Wireless Application Protocol (WAP), including, but not limited to a Handheld Device Markup Language (HDML), such as Wireless Markup Language (WML), WMLScript, JavaScript, Standard Generalized Markup Language (SGML), HyperText Markup Language (HTML), Extensible Markup Language (XML), EXtensible HTML (XHTML), or the like.

Client devices 111-112 may further be configured and arranged to enable a user to provide scripts, commands, or the like, to DCM server 108, to request retrieval, transformation, and/or normalization of data obtained over network 104, from content servers 101-103, and even from client devices 111-112. In one embodiment, a user, programmer, or the like, may prepare database-like structured queries to be scheduled, and/or executed by DCM server 108. Examples of such database-like structured queries are described in more detail below. Client devices 111-112 may employ any of a variety of available applications to develop the scripts, including text editors, word processors, command line interpreters, or the like. Client devices 111-112 may then receive the resulting data from DCM server 108 based on the queries.

Network 104 is configured to couple one computing device to another computing device to enable them to communicate. Network 104 is enabled to employ any form of medium for communicating information from one electronic device to another. Also, network 104 may include a wireless interface, such as a cellular network interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines DSLs), wireless links including satellite links, or other communications links known to those skilled in the art. Furthermore, remote computers and other related electronic devices could be remotely connected to either LANs or WANs via a modem and temporary telephone link. In essence, network 104 includes any communication method by which information may travel between client devices 111-112, and/or content servers 101-103. Network 104 is constructed for use with various communication protocols including wireless application protocol (WAP), transmission control protocol/internet protocol (TCP/IP), code division multiple access (CDMA), global system for mobile communications (GSM), and the like.

The media used to transmit information in communication links as described above generally includes any media that can be accessed by a computing device. Computer-readable media may include computer storage media that typically embodies computer-readable instructions, data structures, program modules, or other data in a transport mechanism and includes any portable or non-portable storage delivery media.

Content servers 101-103 include virtually any network device that may be configured to provide content over a network. In one embodiment, content servers 101-103 are configured to operate as a web site server. Content servers 101-103 are not limited to web servers, however, and may also operate as a messaging server, a File Transfer Protocol (FTP) server, a database server, application server, or the like. Moreover, while content servers 101-103 may operate as other than a website, they may still be enabled to receive and/or send an HTTP communication.

Devices that may operate as content servers 101-103 include personal computers desktop computers, multiprocessor systems, microprocessor-based or programmable consumer electronics, network PCs, network appliances, servers, and the like.

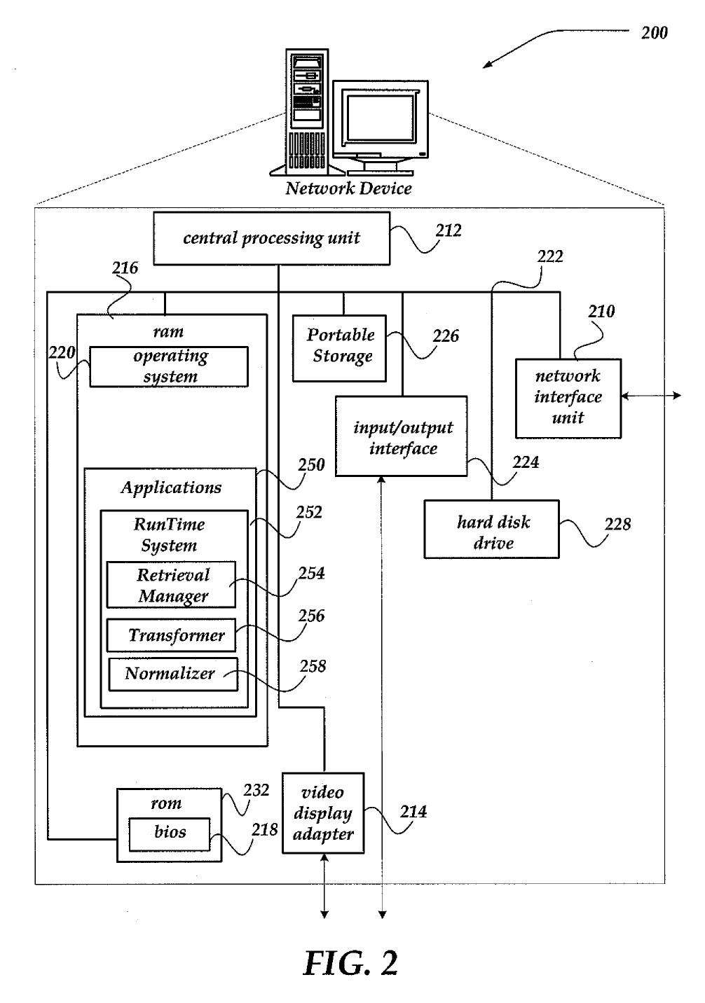

One embodiment of DCM server 108 is described in more detail below in conjunction with FIG. 2. Briefly, however, DCM server 108 includes virtually any computing device that is configured to receive requests for retrieval, transformation, and/or normalization of data obtainable from content servers 101-103, and/or client devices 111-112. DCM server 108 may receive a request in the form of a script, or the like, that employs a database-like structured query language for performing queries. Briefly, a database-like structured query is a query that has a syntax known in the art to be traditionally applicable to searching a database, yet the clauses contained therein are written such that they may be applied to search a broader range of sources, including data not stored in a database format or data from heterogeneous sources. DCM server 108 may then employ the script to crawl though one or more selected content servers 101-103, client devices 111-112, or the like, retrieving, transforming, and/or normalizing the data according to the script. The results may then be provided to the requester over network 104.

Devices that may operate as DCM server 108 include personal computers desktop computers, multiprocessor systems, microprocessor-based or programmable consumer electronics, network PCs, network appliances, servers, and the like.

Although FIG. 1 illustrates DCM server 108 as a single computing device, the invention is not so limited. For example, DCM server 108 may also be implemented across multiple computing devices, without departing from the scope or spirit of the invention. Moreover, one or more retrieving, transforming, and/or normalizing components of DCM server 108 may also be implemented within one or more client devices 111-112.

### Illustrative Network Device

FIG. 2 shows one embodiment of a network device, according to one embodiment of the invention. Network device 200 may include many more components than those shown. The components shown, however, are sufficient to disclose an illustrative embodiment for practicing the invention. Network device 200 may represent, for example, DCM server 108 of FIG. 1.

Network device 200 includes central processing unit 212, video display adapter 214, and a mass memory, all in communication with each other via bus 222. The mass memory generally includes RAM 216, ROM 232, and one or more permanent mass storage devices, such as hard disk drive 228, or the like. Mass memory storage may also include portable storage 226 devices, such as tape drive, optical drive, removable flash memory storage devices, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs may include transcoders, schedulers, calendars, database programs, word processing programs, messaging programs, HTTP/HTTPS programs, customizable user interface programs, IPSec applications, web crawlers, spreadsheet programs, database programs, encryption programs, security programs, FTP servers, and so forth. Runtime System 252 may also be included as application programs within applications 250. In one embodiment, Runtime System 252 may include retrieval manager 254, transformer 256, and normalizer 258. However, the invention is not so limited, and one or more of retrieval manager 254, transformer 256, or normalizer 258 may reside external to Runtime system 252, and/or even on another computing device substantially similar to network device 200.

Retrieval manager 254 is configured to receive a query for data, perform operations over the network to retrieve data requested by the query, and to retrieve the matching data. Examples of database-like structured queries are described in more detail in a co-pending U.S. patent application Ser. No. 09/833,846, entitled “Method And System For Extraction And Organizing Selected Data From Sources On A Network,” which is incorporated herein by reference.

Briefly, sets of query conditions (or clauses) may be created that are used with various network devices to retrieve content from content servers on the network. Typically, the requested content is specified using URLs, but URIs, IP addresses, addresses or locators from other layers of Open Systems Interconnection (OSI) Basic Reference Model, or the like, may also be employed, without departing from the scope of the invention. Data may also be accessed using propriety or non-proprietary protocols or schemes such as FTP, IMAP, ODBC, or the like. In addition, retrieval manager 254 supports additional query structures, including: invoke: where data may be retrieved from an output of executing code in an arbitrary external component; exec: where data may be retrieved from an output obtained by executing an arbitrary external program, and webql: where data may be retrieved by recursively invoking the Runtime System 252 on an arbitrary query script.

Each of these query structures may include one or more retrieval options. For example, when fetching an HTTP URI, the user may provide a specific value for a User-Agent, or the like. The query structure enables a range of other mechanisms that allow scripts to specify such options.

Each supported data retrieval query structure may provide physical access to data in some particular scheme-specific manner. For example, some schemes (e.g., ODBC or the like) may provide programmatic access to data through an Application Programming Interface (API), or the like, in an inherently Record-based manner, in which components of the data are delivered one at a time or in small batches. In another example, other schemes (e.g., http, ftp, etc) may provide access to the data in the form of a stream of bytes. In a third example, other schemes (e.g., file) may provide access to byte data backed by local files.

Furthermore, retrieval manager 254 may access at least two distinct kinds of data, including data (e.g., results from an ODBC or the like) that are inherently Record-based—where the data comprises a number of smaller components, or data (e.g., text/html, application/pdf) that are inherently byte-based—where the data consists of a sequence of bytes that may be interpreted according to their Internet Media Type (IMT).

The approach for content retrieval used by retrieval manager 254 has at least two benefits over more traditional approaches. First, by abstracting details away from the many ways of accessing data, programmers or users can quickly write complex scripts that may perform complex data retrieval processes from heterogeneous sources, instead of having to write long and/or cumbersome programs using traditional methods. Second, substantial performance benefits may be realized by providing a uniform interface to heterogeneous data sources while preserving all data in its native format. “Native” format, as used herein, refers to a format of the data as originally retrieved by the retrieval manager. Active or formal recognition of the “native format” by the retrieval manager is not required so long as the underlying bits that comprise the data are able to be retrieved.

Transformer 256 is configured to automatically perform dynamic data transformation on retrieved data for virtually any form of data regardless of its original native format. For example, in one embodiment, where the retrieved data is a MS WORD® document, the following script may be employed to fetch the document and convert it to plain text.
select *
from http://blahcorp.com/document.doc

In the above example, without explicit indication in the query otherwise, plain text may be chosen as the format to which the document is converted based on a default output format associated with the MS WORD® format, as is further explained below.

As another example, in one embodiment, the following script may be used to convert the document to an HTML format:
select *
from http://blahcorp.com/document.doc
converting to ‘text/html’

As shown above, transformer 256 may convert a wide variety of document formats, using a built-in capability of transforming documents or data sources. Moreover, transformer 256 is configured to employ various intermediate formats to convert to a requested format. For example, a user may request to convert a MS WORD® document into XML. Transformer 256 may perform such transformation, in one embodiment, by determining a sequence of intermediate formats (or IMTs) to employ to ultimately convert the document. Thus, for example, transformer 256 may automatically, and in a manner that the user may be unaware, convert the document into an HTML document, and then convert the HTML document into XML. Similarly, transformer 256 may automatically determine a sequence of intermediate formats to convert an MS EXCEL® document into XML, or the like. One example of such a user script might be:
select *
from http://blahcorp.com/document.doc
converting to ‘text/xml’

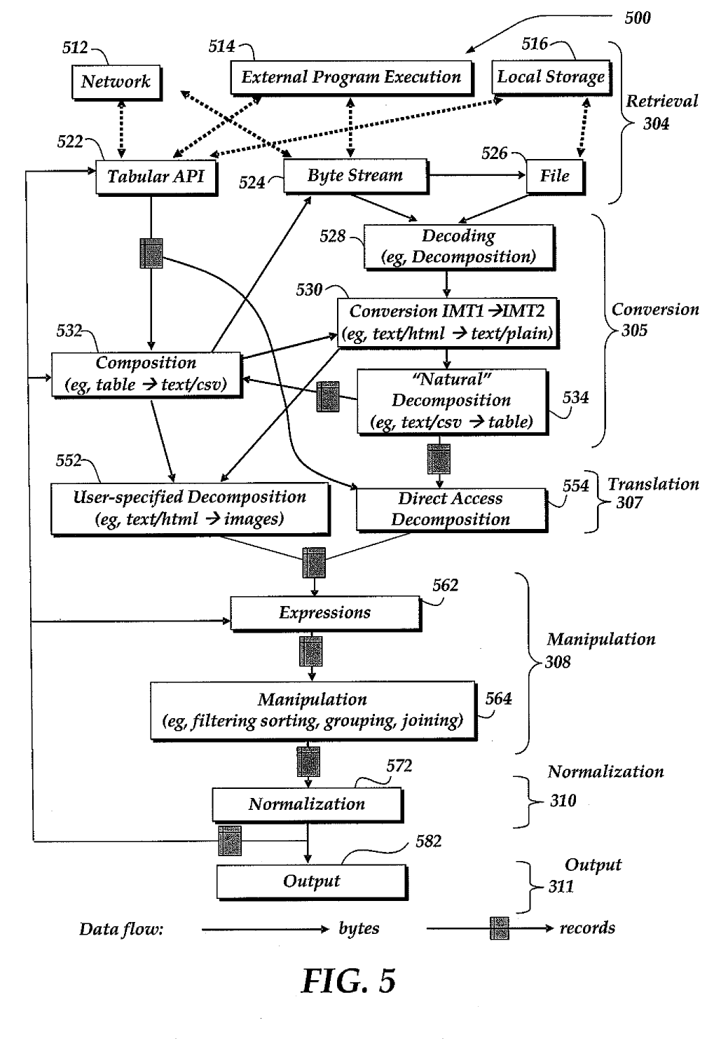

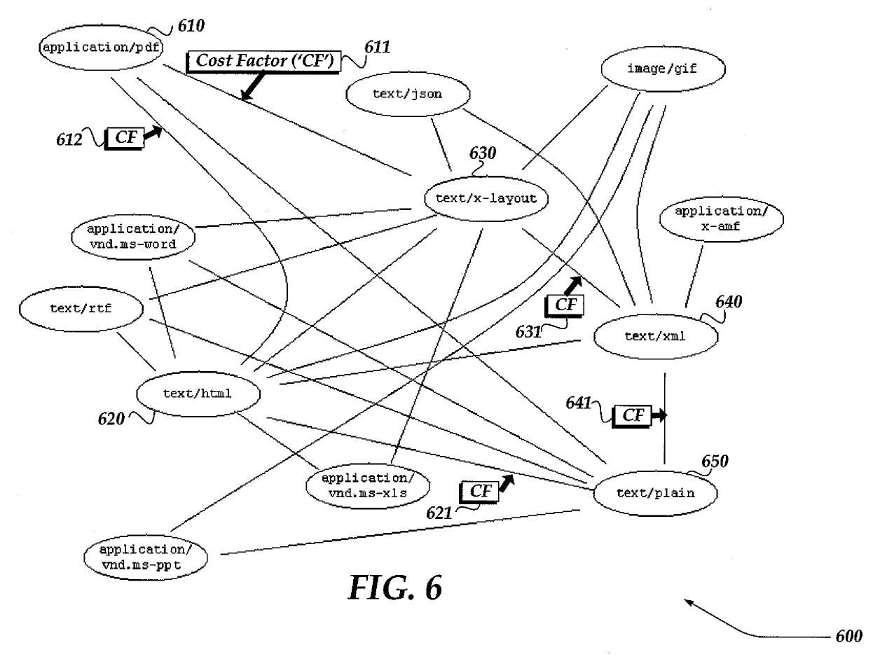

This conversion, as noted above, may be performed automatically, and in a manner, such that the script writer does not need to instruct transformer 256 on the intermediate transformation sequences. Such a conversion process will be further discussed herein with reference to FIGS. 5-6. However, briefly, such a process involves determining a first or starting format from which to start the process and then determining a second or output format for the conversion process. Each of the involved formats, including the first, intermediate, and second data formats, as further discussed herein, is associated with an INT. In the above example, an IMT for MS WORD® is the first determined format and the IMT for text/xml is the second determined format. The intermediate format in the above example is HTML, associated with the NT of ‘text/HTML’. As clearly seen from this example, explicit indication of the intermediate format is absent, or arrived at independently, from any explicit indication of such an intermediate format in the query clauses of the query.

The examples so far have been related to byte-based data. However, transformer 256 is not so limited, and supports record-based data, as well, in which the content may include a sequence of component objects, or the like. Thus, transformer 256 may also convert between byte-based and record-based formats of content, and back again

The invention provides for at least two ways to convert byte-based data to records. The first approach includes converting the bytes to records using a “natural” interpretation associated with the data's IMT. Such a “natural” interpretation, as used herein, pertains to interpreting a document based on a data structure or type of component object associated with the data's IMT. This data structure or type of component object is applicable or recognized among many different IMTs because it pertains to the logical interpretation of the underlying data and not just the IMT in which the data or information is formatted. For example, for text/csv data, a natural interpretation of the bytes as records is one record per physical line in the document, with the records split into columns by “,” (comma) characters according to the definition of the text/csv standard. As a second example, in one embodiment, the natural interpretation of text/html data as records may directly mirror a <TABLE> tag, or related tag types in the data. In one embodiment, the Transformer 256 has a library of procedures like these examples that convert byte-based data to records for a wide variety of IMTs.

A second method that may be employed by Transformer 256 to convert byte-based data to records enables the script writer to specify the sorts of component objects desired. Transformer 256 may extract a wide range of objects from a wide variety of document types. Objects, as referred to herein, and similar to above, pertain to a data structures or manners of data organization that are independent from a particular data format or IMT, yet are recognized and may be logically retained within data of a particular IMT. Thus, for example, in one embodiment, the script writer may extract hyperlinks from within an HTML document using the following:
select *
from links
within http://blahcorp.com/index.html

As shown above, the from clause invokes transformer 256 “links” converter to extract the hyperlinks from within the specified HTML document, passing them onward for possible subsequent processing as a table, or the like, that may include one record for each hyperlink.

In addition, other objects may also be employed as options, including, for example:
Pages—convert a document into a series of sub-documents. For example, one document would be derived for each page, if the document were to be printed.
Lines—where one record is produced for each line in the document.
Images—where one record for each image in a document is produced.
Tables—where data that is formatted in a tabular (e.g., row/column) format is obtained from the document.
Pattern where a regular expression may be specified and one record for each match of the regular expression in a document may be produced.

In one embodiment, for example, a script writer may generate the following, wherein * is defined as a symbol for “all”:
select *
from links
within http://blahcorp.com/document.doc

The script writer may also generate, in another embodiment:
select *
from links
within http://blahcorp.com/document.pdf

As suggested, the output may be converted from MS WORD® or PDF, respectively, to HTML prior to link translation. MS WORD® or PDF are two types of document formats correlated to two different IMTs.

The details of how to implement each of these translations—from text/html to a table of hyperlinks or images, from application/pdf to a table of application/pdf records each representing one page, and the like, may employ a variety of readily available approaches, without departing from the scope of the invention.

Moreover, transformer 256 exposes a series of records substantially similar to how the records may be exposed that are retrieved from a database. Thus, for example, the following queries both convert data to records, where ‘c’ means column and the number indicates a column number:
select c1, c2, c3
from table rows
within ‘odbc: . . . details omitted . . . ’

and
select c1, c2, c3
from table rows
within http://blahcorp.com/index.html

In the first example, data may already be in a desired format. In the second example, the data may automatically be converted from its native format (e.g., searching the HTML data for <TABLE> tags, or the like).

An Internet Media Type (IMT) is a standard machine-understandable label, maintained in a formal registry with the Internet Assigned Numbers Authority, indicating how a given sequence of raw bytes may be interpreted by a computer program. The format of the label refers to a type/subtype for the given data. For example, the IMT text/html indicates that a given piece of content may be interpreted as an HTML document, whereas application/pdf indicates that the content is to be interpreted as a PDF document. IMTs can also indicate that a given sequence of raw bytes is to be interpreted as a composite object comprising several sub-parts. For example, the multipart/mixed IMT indicates that the data is to be broken into several parts, where each part has a distinct IMT. An email message with an attached file is usually encoded as multipart/mixed data with two parts: one part is the email message proper, and the other part is the attachment. As an example, a ZIP archive that includes an HTML file and an Excel spreadsheet may be encoded with IMT application/zip; and then when uncompressed the result may be two objects, one of type text/html and the other of type application/vnd.ms-excel.

Each retrieved data item may include a native IMT. The native IMT is usually specified by the source (although occasionally it is desirable to force a specific native IMT and Runtime System allows scripts to do so).

A Runtime system 252 converter may map a given piece of content together with its IMT, to a new piece of content of a different IMT. Such conversion may be written, in one embodiment as:

C_{IMT1,IMT2}(data)→>data’.

For example, transformer 256 may be configured to provide a converter from text/html to text/plain, which corresponds to a function such as:

C_{text/html,text/plain}(data)→data’.

For example, one example of such function is:

C_{text/html,text/plain}(“<html><body>howdy</body></html>”)+“howdy”.

Transformer 256 may use a variety of procedures to convert data from one IMT to another IMT. As another example, in another embodiment, transformer 256 may use an algorithm to convert application/pdf data into either text/plain or text/x-layout. Transformer 256 may further employ an optical character recognition algorithm to convert any sort of image (e.g., image/* data) to application/rtf, application/vnd.ms-excel, application/vnd.ms-powerpoint, text/html, text/plain, text/x-layout, text/xml, or the like.

In addition, transformer 256 may also provide converters that are configured to extract records from byte-based data. Examples include: a text/html document that can be converted into a series of records each of which describes a single hyperlink in the original document. Similarly, a text/html document can be converted into a table of its images. In addition, transformer 256 may be configured to convert an application/pdf document into a sequence of application/pdf objects that represent each individual page in the original. Transformer 256 may also extract data from text/xml data using XPATH expressions. Transformer 256 in another embodiment, may employ a regular expression to convert any kind of text/* document into a sequence of records indicating the matches. In addition, transformer 256 may also provide converters that extract tabular (row and column) structure from text/* data. Any of a variety of available mechanisms to implement each of these translators may be employed without departing from the scope of the invention.

Taken as a whole, these converters can be represented, in one embodiment, as a directed graph, where nodes indicate IMTs, and there is a transition from node IMT₁ to node IMT₂, where transformer 256 may provide a conversion between the two.

In the course of executing a script, the Runtime System 252 may fetch data from one type IMT₁, and convert it to another type IMT₂. This may be accomplished, in one embodiment, by searching its graph of converters for the shortest path between IMT₁ and IMT₂. This path through the graph corresponds to a sequence of converters that can be applied to the original data to convert it to the desired type. FIG. 6 illustrates one embodiment, of a graph of possible non-exhaustive routes useable to convert from one content format to another content format.

In one embodiment, transformer 256 may automatically determine the most effective way to convert the available data into the format required by a script. The script does not need to specify a “route” (sequence of converters) to take, and script-writers are generally unaware of the various intermediate formats to which their data is converted. Furthermore, in one embodiment, performance may be improved by use of a lazy content conversion, and the data may be cached in case they can be reused for subsequent conversions. That is, transformer 256 may employ lazy evaluation, also called delayed evaluation that includes delaying a computation until such time as the result of the computation is known to be needed.

The approach for transforming data described here may provide several benefits over prior art data retrieval systems. For example, as with retrieval, script-writers or users can generally implement a script to perform a given data retrieval and transformation task using fewer lines of code compared to more traditional programming languages, which may therefore provide benefits in terms of an initial cost of development, as well as a cost of maintenance, and re-use. Considerable performance and scaling benefits may also be realized by retaining a native data format unless and until a different format is required. In addition, a flexible architecture is provided that may make it more straightforward to add or remove capabilities, such as new conversions from one IMT to another, or decoding procedures, new user-directed methods for decomposing bytes into records, and the like.

After the Runtime system has retrieved and transformed some data, a script may specify that it is to be normalized. In one embodiment, the Runtime System may provide a flexible mechanism for normalizing data according to arbitrary application-specific criteria, and taking various actions in case the criteria are not satisfied.

As illustrated in FIG. 2 Runtime System 252 also includes normalizer 258 which is configured to normalize a variety of data including, but not limited to numeric, Boolean, date/time values, or the like. Normalizer 258 provides a mechanism for specifying how to normalize a given piece of data. For example, normalization can involve: matching the data against a regular expression, and return one of the expression's capture groups; matching the data against a set of regular expressions, and return a value associated with the first expression that matches; using an approximate string matching algorithm to find the most similar “canonical” value to the data, or the like. In addition, data may be passed to an arbitrary external element such as a program, subroutine, or script for normalization.

In one embodiment, normalizer 258 enables script-writers to define normalization procedures using a simple XML-based language. For example, to use a regular expression lookup table to normalize a piece of data as a U.S. state, one might use the following notation:

```
<transform>
  <using>
    <lookup>
      <pair><from><regexp>Alabama|ALABAMA|Ala.|AL</regexp>
        </from><to>AL</to></pair>
      <pair><from><regexp>Alaska|ALASKA|Alas.|AK</regexp>
        </from><to>AK</to></pair>
      ...
      <pair><from><regexp>Wyoming|WYOMING|Wyo.|WY
        </regexp></from><to>WY</to></pair>
    </lookup>
  </using>
</transform>
```

As a second example, the following normalization procedure checks a U.S. addresses by making an external communication such as Web Service call (via Perl) to a service such as Geocoder. US's address normalization service:

```
<transform>
  <using>
    <exec>
    perl -e
    “use SOAP::Lite;
    my @lines = < >;
    my $addr = join(‘ ’,@lines);
    my $result = SOAP::Lite
      ->service(‘http://geocoder.us/dist/eg/clients/GeoCoder_test.wsdl’)
      ->geocode($addr)->[0];
    exit(1) unless $result;
    my $zip = $result->{‘zip’};
    exit(2) unless $zip;
    my $number = $result->{‘number’};
    my $prefix = $result->{‘prefix’};
    $prefix .= ‘ ’ if $prefix;
    my $street = $result->{‘street’};
    my $type = $result->{‘type’};
    my $suffix = $result->{‘suffix’};
    $suffix = ‘ ’ . $suffix if $suffix;
    my $city = $result->{‘city’};
    my $state = $result->{‘state’};
    print \“$number $prefix$street $type$suffix, $city $state $zip\”;”
    </exec>
  </using>
</transform>
```

Normalizer 258 may enable script-writers to identify such XML descriptions using a URI, in one embodiment. For example, a script-writer could put the above “US State” XML document at http://mycorp.com/norm/usstate.xml, and then this URI could be used in a script construct to reference the normalization procedure.

Furthermore, normalizer 258 may allow script-writers or users to aggregate any number of such normalization procedures. For example, one embodiment could allow the procedures to simply be concatenated into a large file. In another embodiment, the script-writer could use a mechanism such as the ZIP archive format or the like to encapsulate a number of procedures in an archive). Normalizer 258 may then provide a procedure for normalizing data according to one specific procedure in such an aggregate. Still, in another embodiment, the script-writer could allow the syntax URL#NAME to reference the normalization procedure NAME in the aggregate located at URL (similar to http URLs such as http://blahcorp.com/index.html#loc).

In one embodiment, the operation of Normalizer 258 may occur in more details as follows.
Normalizer 258 may provide built-in normalization procedures that may be reference by certain identifiers, where the use of such an identifier in the input of the normalizer causes a particular built-in normalization procedure to be invoked.
Normalizer 258 may also provide one or more configurable normalization procedures such as (but not limited to) the following: (a) requiring normalization by validation such as, given a regular expression R and a data value V, if R does not match V then signal failure else normalize V to (among other possibilities) one of R's parenthesized capturing groups; (b) given a list of pairs [ . . . , (Rᵢ,Xᵢ), . . . ] where each Rᵢ is a regular expression and each Xᵢ is a literal constant, and a data value V, if V does not match any of the Rᵢ then signal failure else normalize V to (among other possibilities) to Xᵢ where i is the smallest integer such that V matches Rᵢ. (c); (c) given a list of text literals [ . . . , Xᵢ, . . . ] and a data value V, compute a similarity score between V and each Xᵢ (for example, but not limited to, the negative of the Levenstein edit distance) and normalize V to (among other possibilities) the Xᵢ to which V is most similar. These and similar configurable normalization procedures may be implemented using any of a variety of approaches, without departing from the scope of the invention.
Normalizer 258 may also provide the ability to normalize a data value V by invoking or executing an arbitrary external programs, passing the value V to the program (for example, but not limited to, writing V to the program's standard input) and then acquiring the normalized value of V from the program (for example, but not limited to, reading from the program's standard output).

These and similar normalization procedures that may be present in an embodiment of this invention may be implemented using any of a variety of mechanisms, without departing from the scope of the invention.

As well as modifying a given input into some canonical form, normalization procedures can also recognize that no such transformation is possible. If such a fault condition is encountered, in one embodiment, normalizer 258 may allow the script-writer to indicate what action should be taken. Options include (but are not limited to): leaving the original data intact, replacing the data with a special “null” value, halting script execution, or logging the problem in the script execution log.

Normalizing and validating data as described herein may provide several benefits over traditional methods. For example, it may seamlessly integrate standard built-in normalization rules, user-configurable normalization procedures, and invocation of arbitrary external code. In addition, normalization procedures stored, maintained, and re-used across a plurality of data resources including scripts and applications that may be distributed over multiple machines on a network, rather than being bound to a specific column of a particular database table on a particular network location, as in many of the traditional approaches.

### Generalized Operation

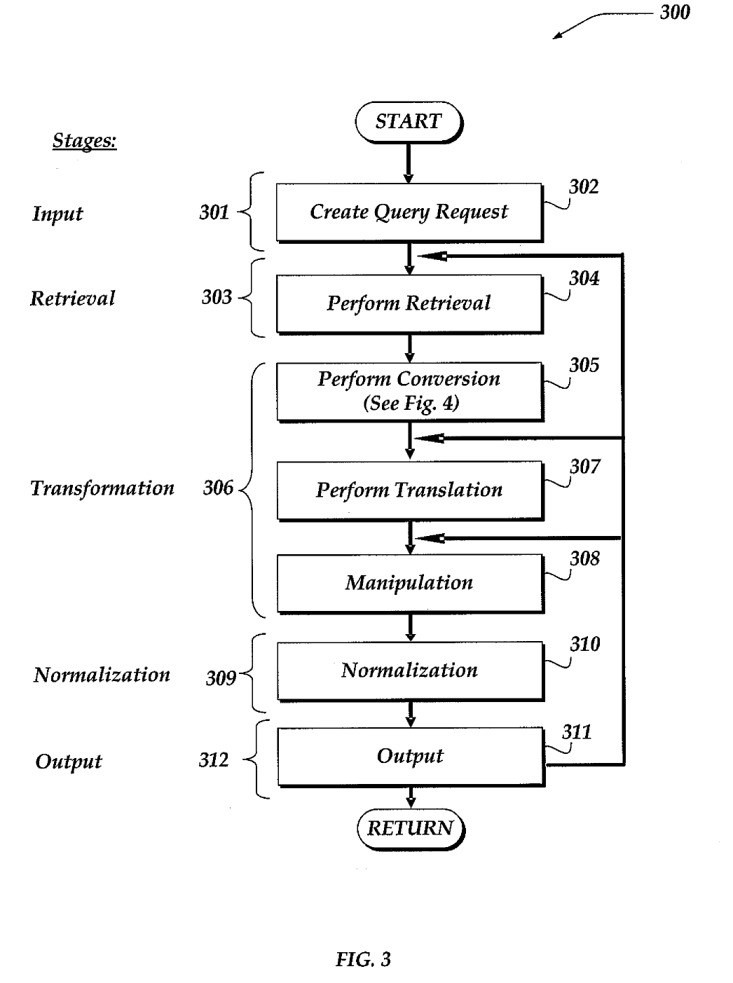

The operation of certain aspects of the invention will now be described with respect to FIGS. 3-6. FIG. 3 illustrates a logical flow diagram generally showing one embodiment of an overview process for managing digital data over a network. In one embodiment, process 300 of FIG. 3 may be performed using client devices, such as client devices 111-112 in communication with DCM server 108 of FIG. 1.

Process 300 begins, after a start block, at block 302, where a script writer, or the like, creates a script that may direct a search and retrieval of data. Such a script, as described above, may be composed using a database-like structured query syntax. However, the query may be performed on non-database structured data, and/or databases, applications, or the like. Moreover, the user may employ the above described select, from clauses, or the like, to create the database-like structured query. The query clauses may then be passed to block 304.

At block 304, the query may be paused to determine which locations such as network sites, applications, and the like, to commence a search, how deep to search a site, and what data to retrieve. In one embodiment, various network crawlers may be employed to search for and retrieve data. In some embodiments, an application may be executed at the network site to obtain the data, a form may be completed to further obtain data, or the like, based on the clauses used within the query.

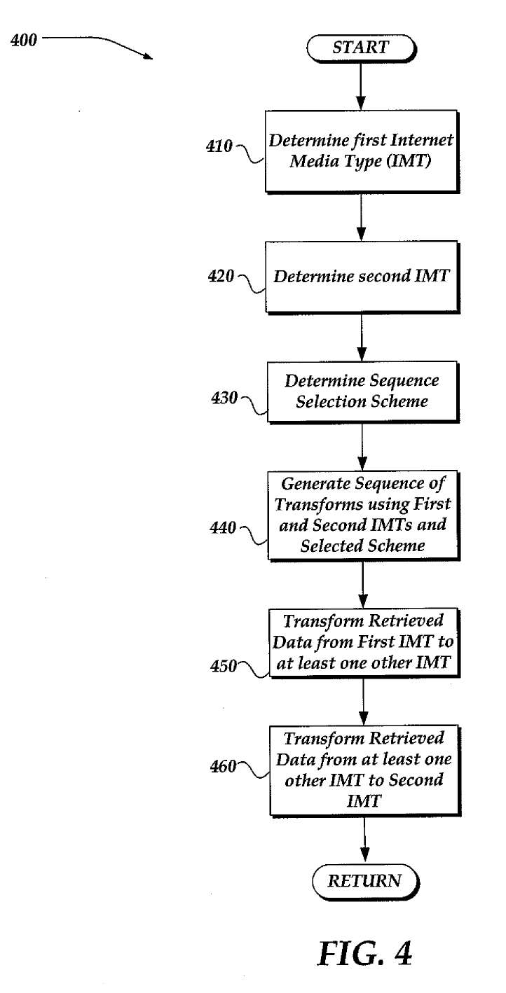

Processing continues to blocks 305 and 307 where the retrieved data may be transformed into another format, again, based, in part, on the clauses within the query. Block 305 is further discussed in details with reference to FIG. 4. Briefly, however, the conversion steps that comprise block 305 include determining at least a first and second data formats, each associated with an IMT, and from such information, generate and perform a sequence of transformations between different IMTs involving at least one intermediate IMT to which retrieved data is transformed prior to being transformed to the determined second IMT.

Processing continues next to block 308, where the data may be manipulated (filtered, sorted, etc), for example, according to application-specific requirements, or the like.

Processing continues to block 310, where the query may also include a request to normalize the data. Thus, at block 310, the retrieved data may be normalized, such as described above. The data may then be provided to the client device of the requester for further actions. Processing continues to block 311, where the data may be output to external files, network devices, or external executing processes, and/or directed back to earlier stages of Process 300. When completed, Process 300 then returns to a calling process to perform other actions.

Also shown in FIG. 3 are stages in which process 300 may be associated. Thus, for example, block 302 may be associated with an input stage 301, while block 304 represents a retrieval stage 303. The retrieval stage 303 may be generally associated with actions performed by retrieval manager 254 discussed above with respect to FIG. 2. Similarly, blocks 305, 307, and 308 represent a transformation stage 306 of actions, generally indicative of the actions performed by transformer 256 discussed above with respect to FIG. 2. In addition, block 310 and its associated actions may represent a normalization stage 309 that is generally indicative of the actions performed by normalizer 258 discussed herein. The output stage 312 may similarly be performed by Run Time System 252 of FIG. 2.

FIG. 4 illustrates a logical flow diagram generally showing the details of one embodiment of a conversion process. Thus, for example, process 400 of FIG. 4 may illustrate further details regarding one embodiment of how a conversion between IMTs may operate.

Process 400 begins, after a start block at block 410, where a first Internet Media Type associated with the retrieved data is determined. As discussed above, the first IMT may be explicitly indicated in the received data or by the source of the retrieved data. Such a first IMT may also be forced upon the retrieved data when desired. The first determined IMT serves as a starting point for generating a sequence of conversions or transforms, as is discussed below with reference to step 440. The first IMT is analogous, though by no manner limited, to a starting node, such as node 610, in the translation graph 600 shown in FIG. 6 and further discussed in more detail below.

Next, the process 400 continues to block 420 where a second IMT to be associated with the retrieved data is determined. In one embodiment, the second IMT may be explicitly entered in a query clause, such as through a “convert to” clause in above noted examples. The second IMT may also be implicitly determined based on the intended use of the data, as suggested by component objects referenced in a query clause such as “select” clause in the above noted examples. The second IMT may also be implicitly determined from an indication, locally stored with Run Time System 252 or otherwise, of a default IMT associated with the native IMT of the data source. A default IMT may also be stored and used as the second IMT for all sequences of conversions made by Transformer 256 of FIG. 2. Either of these latter two default IMTs may be indicated as a default by the user or encoded into the application 250 as originally written. This second determined IMT serves as the finishing point or end for the generated sequence, as discussed below with reference to block 440. The second IMT may also be further analogous to, though in no manner limited, to a finishing node, such as node 650, in the translation graph 600 shown in FIG. 6 and further discussed herein.

Next, processing flows to block 430, where a sequence selection scheme is determined from a plurality of predetermined selection schemes that are available for application. Each available selection scheme may at least define the criteria or principles that may be applied to determine an ideal or preferred sequence. Such a determined selection scheme may include, though is not limited to, at least one of a logically shortest sequence, a lowest computational cost, or a computational fastest sequence. The logically shortest sequence refers to the fewest number of total transformations between a given first IMT and second IMT, regardless of other factors such as computational cost or speed, or the like. The lowest computational cost scheme refers to selecting the sequence of conversions that consumes the fewest resources, regardless of speed or number of transforms, or the like. The computationally fastest sequence refers to selecting the sequence that completes the conversion in the shortest amount of time, regardless of the number of resources consumed or number of transforms, or the like. Determining which of these selection schemes, or others not listed herein but also applicable, may be based on explicit indication in a query clause. The employed sequence selection scheme may also be determined from an indication, among available schemes, of a default scheme when, for example, no particular scheme is indicated in a query.

After at least this minimal amount of information is determined, processing flows to block 440 where a sequence of transforms may be generated using the first and second IMTs and the sequence selection scheme. Using the first and second IMTs as initial and final conversion formats, respectively, the generation comprises application of the sequence selection scheme to generate a sequence of transforms that best meets or conforms to the principles for the sequence selection scheme. For example, the generated sequence may be based on a shortest path between the first and second IMTs in the translation graph. Alternately, such a generated sequence may be determined using a computational cost factor associated with each available transformation between one IMT to another IMT. Application of either of these schemes is further discussed below with regard to FIG. 6. Briefly, however, application of any such scheme effectively imposes a particular selection criteria in the generation of a preferred sequence of transforms. The output or resulting information passed from this step comprises a determine sequence of transforms, including at least one IMT other than the determined first and second IMTs.

After the generation of the sequence at block 440, processing continues to blocks 450 and 460, where the conversions or transformations represented in the sequence are formally applied to the received data. That is, at block 450, a transform or sequence of transforms is applied to the received data, which has been associated with a determined first IMT, to convert the received data into a format consistent with at least one intermediate format. After this application of transforms, the retrieved data is converted at block 460 from the at least one other or intermediate IMT to the data format consistent with the second IMT. Regardless of path or length of sequence, such transformations may be performed without further input or even breaks between the involved steps of transformation. After application of process 400 to received data, the process returns to perform other types of data handling, including, but not limited to normalization, such as described above in conjunction with FIG. 3.

FIG. 5 illustrates a data flow diagram 500 showing one embodiment of details of the process illustrated in FIG. 3.

The retrieval stage 304 from FIG. 3 is illustrated further in diagram 500 of FIG. 5 as including retrieving data from one or more (but not limited to) the following: one or more computer networks 512, one or more executing external programs 514, and one or more local storage systems 516. Retrieval 304 also allows for one or more (but not limited to) writing data to local storage 516, pushing records to a device on network 512 or external executing program 514 using, for example, a programmatic API.

The conversion stage 305 from FIG. 3 is illustrated further in diagram 500 of FIG. 5 as fetching of data using one or more of (but not limited to) the following three mechanisms. However, other mechanisms may be employed without departing from the scope of the invention. Tabular API 522 refers to any programmatic interface to a network or an executing external program that retrieves a sequence of record-based data. Byte stream 524 refers to any protocol for accessing data from a network of an executing external program that generates a stream of bytes. File 526 refers to any programmatic interface for accessing data such as files and the like in local storage.

The transitions in FIG. 5 from byte stream 524 to file 526 indicates that the byte stream method may have the capability to read the entire byte stream and store the result in local storage 516 so that the bytes may be accessed as if they had originated from a file in the local storage.

Decoding 528 includes procedures for decoding, decompressing, decrypting, de-archiving, character set transcoding, and other similar operations. The transitions from byte stream 524 to decoding 528, and from file 526 to decoding 527, indicate that decoding 528 may be configured to operate on byte data originating from a native byte stream or data from local storage.

Conversion 530 includes procedures for automatically converting data from one Internet Media Type (IMT) to another IMT, as explained in FIG. 6. The transition from decoding 528 to conversion 530 indicates that any byte stream or file-based data can be converted to another IMT (after any decoding is performed by the decoding 528). The transition from conversion 530 to itself indicates that converting from one IMT to a desired IMT may involve automatically converting the data to a sequence of one or more intermediate IMTs.

The natural decomposition 534 includes converting data from some IMT using the particular conventional view of the IMT in terms of records. For example, the conventional view of a text/csv document in terms of records, may involve generating one record per physical line, with records delimited by commas as specified by the text/csv standard. Many IMTs have similar conventional decompositions into records. The transition from conversion 530 to natural decomposition 534 indicates that data of any IMT can be converted to records using its conventional decomposition into a default data structure, including potentially mixed or just a single data structure.

Composition 532 includes a process of aggregating records into a sequence of bytes formatted according to a specific IMT. For example, a table (sequence of records) can be composed into text/csv according to the text/csv standard. The transition from tabular API 522 to composition 532, and from natural decomposition 534 to composition 532, indicate that records from be composed into bytes, regardless of their origin. The transition from composition 532 to conversion 530 indicates that the bytes generated from a set of records may be converted into another IMT if required. The transition from composition 532 to byte stream 524 indicates that an embodiment may permit a set of composed records to be pushed over network 512 to a network device that can receive it, or passed to an executing external program 514 for processing, backed by file 526, or the like.

Translation 307 includes a process of applying additional transformations to the bytes or records retrieve, decoded, converted, composed, and/or decomposed from their sources. User-specified decomposition 552 refers to applying one of many non-conventional procedures to extracted records from bytes, such as (but not limited to) extracting links from HTML, images from HTML, individual pages from PDF, etc. The user-specified decomposition 522 was described in greater detail previously in this document. The transitions from composition 532 to user-specified decomposition 553 and from conversion 530 to user-specified decomposition 552 indicate that user-directed decompositions can be invoked on any byte data with an associated IMT, regardless of origin. Direct-access decomposition 554 refers to any form of selection, reconfiguration, or filtering of a set of records. For example, an embodiment may enable the elimination or renaming of columns in tabular data produced by a tabular API 522, or a natural decomposition 534, or the like.

Manipulation 308 includes generating and combining expressions over the columns in a set of records. One embodiment may allow one or more of (but are not limited to) the following: arithmetic operations, string operations, logical operations, date/time operations, array operations, and the like, or arbitrary compositions of such operations. For example, a user-specified decomposition 552 may generate records containing the hyperlinks in a text/html document where each record comprises the anchor text and the destination URL, and manipulation 308 may allow an expression 562 that is the concatenation of the link anchor text, followed by “(” (parenthesis) followed by the destination URL, followed by “)” (parentheses). These expressions generally correspond directly to the logic of the application being implemented. Manipulation 564 refers to the use of arbitrary expressions 562 in order to perform standard database operations on the data, such as (but not limited to) filtering, sorting, grouping, aggregating and/or joining the data.

Normalization 310 includes validating the data to check that it satisfies specific constraints as specified in normalization 572, and/or modifying the data to ensure that the constraints are satisfied. Normalization was described in great detail previously in this document.

Output 311 includes passing of records on for subsequent processing. The transitions from output 311 to tabular API 522, and from output 311 to composition 532, indicate that an embodiment may direct that the entire process depicted in FIG. 5 be recursively invoked on a set of records. The transition from Output 311 to expression 562 indicates that an embodiment may allow expressions to be recursively defined in terms of the output of other expressions. As a whole, each of these ‘cycles’ in FIG. 5 indicates that a query can have multiple ‘segments’ (or “steps” or “stages”). Each segment may correspond to one pass from top to bottom. Initial segments for a given portion of data go out to the data sources to retrieve the data; but ‘internal’ segments get their data from prior segments. For example, a script to get the contents of each article on the front page of the New York Times, might have two segments (a) first, ask nytimes.com for all outgoing links that match the pattern ‘nytimes.com/article?id=XXXXXX’ (e.g., ignore links to non-articles); and then (b) fetch the article from each such link. Subsequent segments could repeat actions imposed upon a segment, such as prune advertisements from article text or extract a byline. The arrows from the bottom of FIG. 5 diagram to the top correspond to segment (a) passing the links it has discovered to segment (b). Each set of retrieved data may be repeatedly processed through the same parts of the system, though in different stages of the overall handling of the retrieved data before it is finally sent to Output 311.

FIG. 6 illustrates one embodiment of a translation graph 600 for converting between data types. Visually, this generation of a sequence, as noted above for block 440 of FIG. 4, refers to selecting and providing indication of a best path between nodes in translation graph 600. For example, with particular reference to FIG. 6, conversion from an IMT determined as a first IMT, such as ‘application/pdf’ (node 610) to an IMT determined as a second INT, such as ‘text/plain’ (node 650), may be enabled through a plurality of paths. For example, a conversion may be made from first IMT (node 610) to an intermediate IMT (node 620), ‘text/html’, and then from the intermediate IMT (node 620) to the second NT (node 650). Alternately, a second viable conversion path may exist through conversions between the first IMT (node 610) to an intermediate IMT (node 630), and then from the IMT (node 630) to another intermediate INT (node 640), and then from the other IMT (node 640) to the determined second and final IMT (node 650). Applying the logically shortest path scheme to such a context would, with regard to these two particular and exemplary paths, result in the path through IMT (node 620) being the generated path, since it involves a smaller number of logical conversions between IMTs.

Application of the other two schemes, the lowest computational cost scheme and the computationally fastest sequence scheme, would involve assessment of the cost factors, such as cost factors 611, 612, 621, 631, and 641, which are shown in FIG. 6 as being associated with each segment of the two paths discussed above. Between these two paths, the generated path for either of these schemes may be based on actual values for each transformation in the overall sequence or path. Assessment of an overall path may involve the summation of the involved cost factors given for each individual transformation from which the path is constructed. Again, these two paths are merely examples of possible paths, whereby another path generation may involve consideration of other paths, if not all other paths, between the determined first and second IMTs. As noted above, the involvement of an intermediate IMT in a generated path, rather than a direct transform or conversions between the first and second IMTs, may be based on the intended use of the retrieved data, including for extraction of a particular component object or record, or even an explicit conversion clause in the created query. Additionally, a direct conversion between the determined first and second IMTs may not be possible with the conversions provided for the application 250. Further, while not shown in the graph, each of these paths may represent an available conversion that bidirectional, or “from” and or “to” either of the two linked two formats. Alternately, each of the paths in the graph may indicate just a unidirectional conversion between the two linked formats, such that the conversion may only be “from” one IMT and only “to” the other IMT. Any combination of bidirectional or unidirectional conversions may be included or applied in the system.

Cost factors, such as factors 611 and 641, are shown in FIG. 6 as being associated with only a few translation paths for purposes of clarity and readability. In one embodiment of data stored for the involved conversions, each and every such conversion or path may have an associated cost factor that is predetermined and/or estimated. With regard to the actual storage of the contents of this graph in a memory, the data structure equivalent of this translation graph may be stored as a table, wherein each line of the table references a single, individual conversion in terms of the different input and output IMTs of the conversion, as well as possibly a cost factor comprising a numerical indication of the computational resources and/or time required for the conversion. The contents of the table, or other applicable data structure, indicate the conversions formally available to a system at the time of execution. Additional or alternative conversions may be included into the table by installing the new or different conversions within Run Time System 252 of FIG. 2, before or after the generation of a sequence. Similarly, conversions that are no longer available to the Run Time System 252 may be removed from such a table.

Regardless of the manner in which a sequence is determined, the resulting generated sequence from block 440 may include at least one intermediate IMT, as discussed above. Such a sequence would also include of the necessary conversions to and from this at least one intermediate IMT. This at least one intermediate IMT is included in the resulting sequence in a manner that is independent of any explicit indication the IMT within any query clause in the query. Rather, this at least one other IMT may be determined based on a query clause in the query that indicates at least one component object from which at least one record is extracted from the retrieved data. As noted above, if a component object indicated in a query clause references tables, then the initial or first IMT, prior to converting to a second and final IMT, needs to be converted to an IMT that is also compatible with the indicated component object. The fulfillment of this requirement is apparent in the generated sequence. An end user may be unaware of this necessary conversion, yet is still able to obtain data from an otherwise incompatible IMT through the application of the conversion process 400 disclosed herein.

It will be further understood that each block of the flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowcharts to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A system useable for managing data over a network, comprising:
a retrieval component that is configured to retrieve data using a database-like structured syntax language query, wherein the retrieved data is retrieved from at least one data source indicated in the query;
a transformer component that is configured to transform at least a portion of the retrieved data from a first Internet Media Type (IMT) to a second IMT by transforming the retrieved data from the first IMT into at least one other IMT before transforming the received data into the second IMT using an automatically generated sequence of transformations between different IMTs; and
a normalizer component that is configured to validate that the transformed data is in an application specific format consistent with a query clause in the query.

2. The system of claim 1, wherein the automatically generated sequence is determined at least based on a shortest path between the first and second IMTs in a translation graph.

3. The system of claim 1, wherein if the normalizer component determines that the transformed data is inconsistent with the query clause, then the normalizer component is configured to perform actions, including modifying the transformed data into a format consistent with the query clause.

4. The system of claim 1, wherein the transformer component automatically generates the sequence of transformations by performing actions, including:
determining the first IMT based on the retrieved data;
determining the second IMT based on an explicit query clause in the query; and
determining a selection scheme from one of a plurality of predetermined selection schemes including at least one of a logically shortest sequence, a sequence with a lowest computational cost, or a computationally fastest sequence.

5. The system of claim 1, wherein the at least one other IMT is independent of an explicit indication of the at least one other IMT within any query clause in the query.

6. The system of claim 1, wherein the automatically generated sequence is determined using a computational cost factor associated with each available transformation between one IMT and another IMT.

7. The system of claim 1, wherein the at least one other IMT is determined based on a query clause in the query that indicates at least one component object from which at least one record is extracted from the retrieved data.

8. A computer readable storage medium encoded with instructions that when executed by a computer cause the computer to perform actions for retrieving data, comprising:
retrieving data using a database-like structured syntax language query, wherein the retrieved data is retrieved from at least one data source indicated in the query;
transforming at least a portion of the retrieved data from a first Internet Media Type (IMT) to a second IMT by transforming the retrieved data from the first IMT into at least one other IMT before transforming the received data into the second IMT using an automatically generated sequence of transformations between different IMTs; and
validating that the transformed data is in an application specific format consistent with a query clause in the query.

9. The computer readable storage medium of claim 8, wherein the automatically generated sequence is determined based on a shortest path between the first and second IMTs in a translation graph.

10. The computer readable storage medium of claim 8, wherein if the transformed data is inconsistent with the query clause, further performing actions, including modifying the transformed data into a format consistent with the query clause.

11. The computer readable storage medium of claim 8, wherein the at least one other IMT is independent of an explicit indication of the at least one other IMT within any query clause in the query.

12. The computer readable storage medium of claim 8, wherein the actions further comprise generating a sequence of transformations by performing actions, including:
determining the first IMT based on the retrieved data;
determining the second IMT based on an explicit query clause in the query; and
determining a selection scheme from one of a plurality of predetermined selection schemes that includes at least one of a logically shortest sequence, lowest computational cost, or computational fastest sequence.

13. The computer readable storage medium of claim 8, wherein retrieving the data further comprises:
initiating execution of a remote application;
automatically interacting with the remote application by providing an input to a request for input from the application; and
receiving at least one response data from the executing remote application.

14. The computer readable storage medium of claim 8, wherein the automatically generated sequence is determined using a computational cost factor associated with each available transformation between one IMT to another IMT.

15. The computer readable storage medium of claim 8, wherein the at least one other IMT is determined based on a query clause in the query that indicates at least one component object from which at least one record is extracted from the retrieved data.

16. A network device for retrieving data, comprising:
a processor; and
a memory storing data that when executed by the processor performs actions, comprising:
retrieving data using a database-like structured syntax language query, wherein the retrieved data is retrieved from at least one data source indicated in the query;
transforming at least a portion of the retrieved data from a first Internet Media Type (IMT) to a second IMT by transforming the retrieved data from the first IMT into at least one other IMT before transforming the received data into the second IMT using an automatically generated sequence of transformations between different IMTs; and
validating that the transformed data is in an application specific format consistent with a query clause in the query.

17. The network device of claim 16, wherein if the transformed data is inconsistent with the query clause, then further performing actions, including modifying the transformed data into a format consistent with the query clause.

18. The network device of claim 16, wherein the actions comprise generating a sequence of transformations by performing further actions, including:
determining the first IMT based on the retrieved data;
determining the second IMT based on an explicit query clause in the query; and
determining a selection scheme from one of a plurality of predetermined selection schemes that includes at least one of a logically shortest sequence, lowest computational cost, or computational fastest sequence.

19. The network device of claim 16, wherein the automatically generated sequence is determined using a computational cost factor associated with each available transformation between one IMT to another IMT.

20. The network device of claim 16, wherein the at least one other IMT is determined based on a query clause in the query that indicates at least one component object from which at least one record is extracted from the retrieved data.
